(19) United States
(12) Patent Application Publication
(10) Pub. No.: US 2005/0242012 A1
(43) Pub. Date: Nov. 3, 2005

(54) One-piece anti-drain back valve allowing relief valve flow

(76) Inventor: L. Steven Cline, Fayetteville, NC (US)

Correspondence Address: CARLSON, GASKEY & OLDS, P.C., 400 WEST MAPLE ROAD, SUITE 350, BIRMINGHAM, MI, 48009, US

(21) Appl. No.: 10/834,422

(22) Filed: Apr. 29, 2004

(51) Int. Cl. B01D 35/147

(52) U.S. Cl. 210/130; 210/136; 210/440; 210/443; 210/433.1

(57) ABSTRACT

An oil filter includes a housing defining a cavity. The housing includes an aperture for providing fluid to the cavity. A filter assembly having a filter media is arranged in the cavity and separates the cavity into an inlet side and an outlet side. A relief valve assembly has a relief valve movable to selectively fluidly connect the inlet and outlet sides to bypass the filter media. An anti-drain back valve includes a closed position sealing the aperture in the housing from the cavity while permitting a fluid connection between the aperture in the housing and the relief valve. The relief valve assembly includes a relief valve retainer supporting the relief valve. The anti-drain back valve includes a wall spaced from the relief valve retainer forming a chamber. Apertures in the wall and holes in the relief valve fluidly connect the aperture of the housing to the relief valve throughout various positions of the anti-drain back valve.

### BACKGROUND OF THE INVENTION

This invention relates to an anti-drain back valve for a fluid filter such as an oil filter. More particularly, the invention relates to an anti-drain back valve that does not obstruct fluid flow to a relief valve.

Fluid filters, such as oil filters (also referred to as simply a “filter”) typically incorporate an anti-drain back valve and a relief valve. The anti-drain back valve moves from an open position to a closed position when fluid flow to the filter has stopped thereby preventing dirty fluid from exiting the filter. The relief valve is used to bypass fluid flow through a filter media within the filter when an undesirably high filter pressure is reached, such as when the filter media becomes blocked or when the fluid is very viscous.

In one typical filter arrangement, the relief valve is arranged between a portion of an end disc supporting the filter media and a relief valve retainer. A spring is arranged between the end disc and the relief valve to bias the relief valve to a closed position. The relief valve retainer has multiple holes about its circumference, which exposes the relief valve to pressurized fluid within the filter. At a predetermined fluid pressure, the relief valve compresses the spring permitting fluid to flow through the holes in the relief valve retainer and bypass the filter media.

The anti-drain back valve is retained between the relief valve retainer and a tapping plate, which secures the filter to an engine, for example. The anti-drain back valve opens to permit fluid to flow into the filter and to the filter media to filter the fluid. However, the anti-drain back valve can deflect until it engages the end disc, which prevents fluid from flowing through the holes to the relief valve. This can starve the engine of oil during a cold start or in the case of a dirt clogged filter media. Therefore, what is needed is an improved anti-drain back valve arrangement permitting flow of fluid to the relief valve throughout various operating positions of the anti-drain back valve.

### SUMMARY OF THE INVENTION AND ADVANTAGES

The present invention provides a fluid filter such as an oil filter including a housing defining a cavity. The housing includes an aperture for providing fluid to the cavity. A filter assembly having a filter media is arranged in the cavity and separates the cavity into an inlet side and an outlet side. A relief valve assembly has a relief valve movable to selectively fluidly connect the inlet and outlet sides to bypass the filter media. An anti-drain back valve includes a closed position sealing the aperture in the housing from the cavity while permitting a fluid connection between the aperture in the housing and the relief valve. The relief valve assembly includes a relief valve retainer supporting the relief valve. The relief valve retainer includes holes. The anti-drain back valve includes a wall spaced from the relief valve retainer, forming a chamber. The wall includes apertures. The apertures in the wall and the holes in the relief valve retainer fluidly connect the aperture of the housing to the relief valve throughout various positions of the anti-drain back valve. In this manner, flow of fluid to the relief valve is not obstructed.

The anti-drain back valve is provided by a generally annular body having a generally V-shaped cross-section. The generally annular body includes an apex providing a first sealing portion. A first generally annular leg extends from the apex for providing an anti-drain back feature. A second generally annular leg extends from the apex to a second sealing portion and is transverse to the first generally annular leg. The second generally annular leg provides the wall having the apertures. Since the wall is spaced from the relief valve retainer and provides the chamber, the apertures in the wall and the holes in the relief valve retainer need not be aligned.

Accordingly, the above invention provides an anti-drain back valve that permits fluid flow to the relief valve through the various positions of the anti-drain back valve.

### BRIEF DESCRIPTION OF THE DRAWINGS

Other advantages of the present invention can be understood by reference to the following detailed description when considered in connection with the accompanying drawings wherein:

FIG. 1 is a cross-sectional view of a fluid filter incorporating the inventive anti-drain back valve.

FIG. 2 is a top perspective view of the inventive anti-drain back valve.

FIG. 3 is a cross-sectional view of the anti-drain back valve as shown in FIG. 2 taken along line 3-3.

FIG. 4 is a bottom perspective view of the anti-drain back valve shown in FIG. 3.

### DETAILED DESCRIPTION OF THE PREFERRED EMBODIMENT

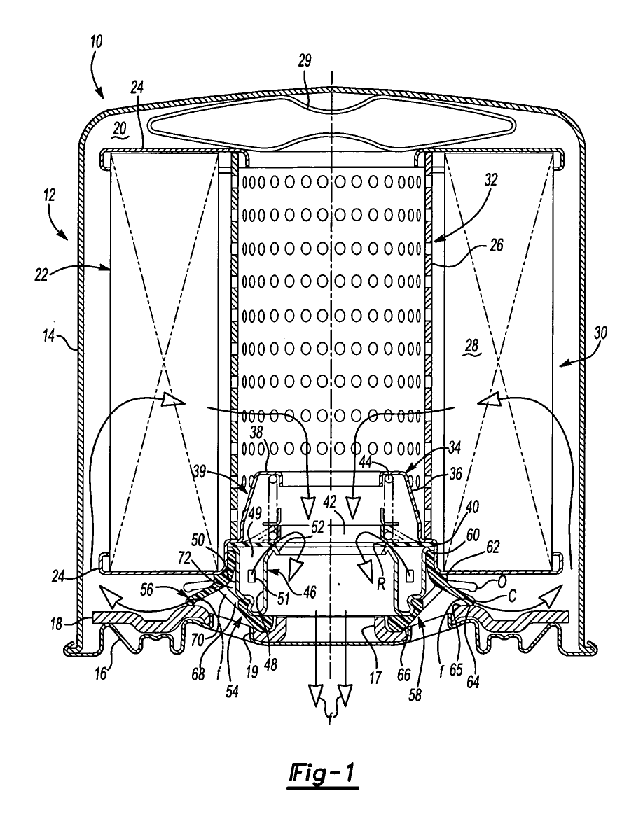

FIG. 1 illustrates a fluid filter 10, and more particularly, an oil filter. However, the invention may be used with any type of fluid filter. The fluid filter 10, also commonly referred to as the “filter”, includes a housing 12 having a can 14. A retainer 16 is crimped to the can 14 at one end. The retainer 16 is arranged adjacent to a tapping plate 18 having a central threaded hole 17 providing a fluid outlet for the filter 10. The tapping plate 18 also includes inlet apertures 19 arranged circumferentially on the tapping plate 18 providing an inlet to a cavity 20 of the filter 10. The filter 10 may be secured to an engine block or remote oil filter adapter for receiving oil from an engine to filter particulates from the oil.

A filter assembly 22 is arranged within the cavity 20. The filter assembly 22 includes opposing end discs 24 having a center tube 26 with multiple perforations. A filter media 28, such as a paper pleated filter element, is arranged between the end discs 24 outwardly of the center tube 26. The filter media 28 separates the cavity 20 into an inlet side 30 and an outlet side 32. Fluid flow, f, is shown by arrows in FIG. 1. However, it should be appreciated that the inlet 30 and outlet 32 sides may be reversed depending upon the flow direction desired.

An end spring 29 is arranged between a bottom surface of the can 14 and an end disc 24 to bias the filter assembly 22 toward the tapping plate 18 ensuring desired sealing within the filter 10.

A relief valve assembly 39 includes an annular support 34 extending from the end disc 24 near the tapping plate 18 and a relief valve 40 movable to selectively fluidly connect the inlet 30 and outlet 32 sides. The annular support 34 has an axial portion 36 and a radial portion 38 extending from the axial portion 36. An outer circumferential area of the relief valve 40 is retained between the annular support 34 and a relief valve retainer 46. A spring 44 is arranged between the radial portion 38 and an annular flange 42 that abuts an inner circumferential area of the relief valve 40. The spring 44 biases the relief valve 40 to a closed relief valve position R.

The relief valve retainer 46 includes an inner wall 48 having a sealing surface 52 against which the inner circumferential area of the relief valve 40 seals, and an outer wall 50 having multiple holes 51. The inner and outer walls 48 and 50 are spaced from one another forming a cavity 49. Pressurized fluid within the cavity 49 forces the relief valve 40 upward compressing the spring 44 when the fluid pressure reaches a desired pressure, thereby circumventing the filter media 28 and directly connecting the inlet 30 and outlet 32 sides. The relief valve 40 is typically designed to open when the filter media 28 becomes clogged or when the oil is very viscous.

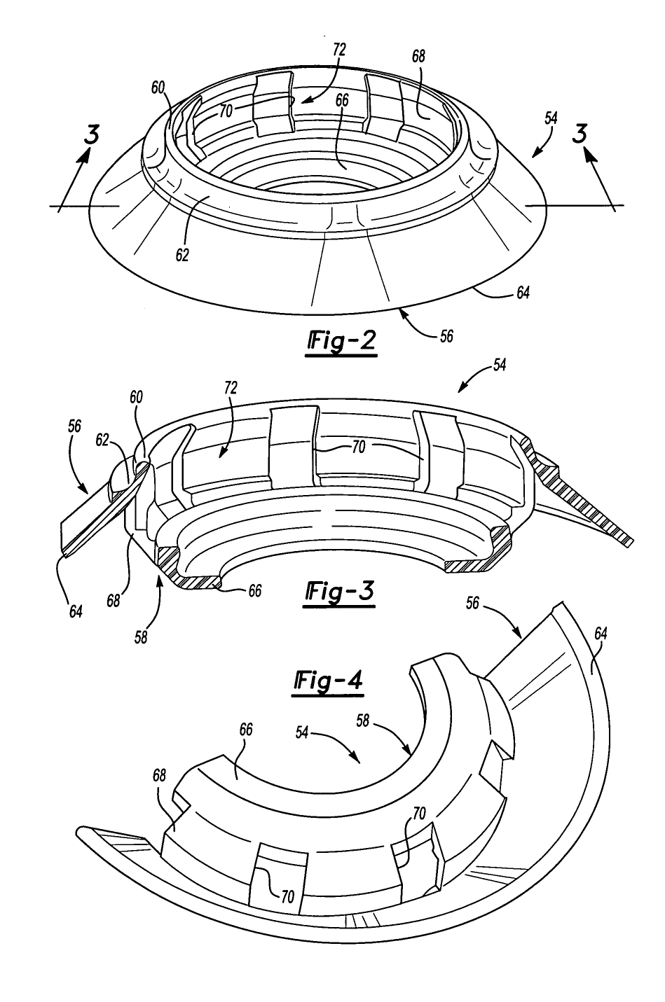

An inventive one-piece anti-drain back valve 54, shown in FIGS. 1-4, is configured to work with prior art filters 10 having the relief valve assembly 39 described above. The anti-drain back valve 54 includes a body that is generally annular in shape having a generally V-shaped cross-section. The anti-drain back valve 54 includes an apex providing a first sealing portion 60. The first sealing portion 60 is retained between the relief valve retainer 46 and end disc 24. A first leg 56 extends from the first sealing portion 60 to provide an anti-drain back feature. In the example shown, the first leg 56 is at an acute angle relative to the end disc 24. A second leg 58 extends from the first sealing portion 60 transverse to the first leg 56. The first and second legs 56 and 58 are generally annular and are arranged at approximately a right angle relative to one another in the example shown.

The first sealing portion 60 is arranged between the relief valve retainer 46 and end disc 24. The first leg 56 includes a fulcrum 62 about which an annular lip 64 of the first leg 56 pivots between a closed position C and an open position O (shown in phantom in FIG. 1). The annular lip 64 seals against a sealing surface 65 provided by the tapping plate 18.

The second leg 58 includes a second sealing portion 66 arranged between the relief valve retainer 46 and the tapping plate 18. The second leg 58 provides a wall 68 that is spaced from the relief valve retainer 46 to provide an annular flow chamber 72. The wall 68 includes multiple apertures 70 arranged about its circumference. The outer wall 50 of relief valve retainer 46 includes holes 51 arranged about its circumference. The apertures 70 in the wall 68 and the holes 51 in the relief valve retainer 46 need not be aligned since the annular flow chamber 72 is provided, which communicates fluid from the apertures 70 in the wall 68 through the holes 51 in the relief valve retainer 46 to the cavity 49.

As can be appreciated from the Figures, if the annular lip 64 engages the end disc 24, the anti-drain back valve 54 will not obstruct fluid flow from the inlet apertures 19 in the tapping plate 18 to the relief valve 40.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

1. A fluid filter comprising:
a housing defining a cavity and an aperture for providing fluid to the cavity;
a filter assembly arranged in the cavity separating the cavity into an inlet side and an outlet side;
a relief valve assembly having a relief valve movable to selectively fluidly connect the inlet side and the outlet side; and
an anti-drain back valve including a closed anti-drain back valve position sealing the aperture from the cavity while permitting a fluid connection between the aperture and the relief valve.

2. The fluid filter according to claim 1 wherein the relief valve assembly includes a relief valve retainer and a spring biasing the relief valve against the relief valve retainer in a closed relief valve position, the relief valve retainer including a hole fluidly connecting the aperture to the relief valve.

3. The fluid filter according to claim 2 wherein the filter assembly includes an end disc supporting a filter media, the anti-drain back valve having a first sealing portion supported between the end disc and the relief valve retainer.

4. The fluid filter according to claim 3 wherein the spring is arranged between the end disc and the relief valve.

5. The fluid filter according to claim 3 wherein the housing includes a tapping plate having a central threaded hole, the tapping plate providing the aperture in the housing, and a second sealing portion of the anti-drain back valve arranged between the tapping plate and the relief valve retainer.

6. The fluid filter according to claim 1 wherein the anti-drain back valve is generally annular in shape with a generally V-shaped cross-section, the anti-drain back valve including a first generally annular leg providing a sealing lip movable between an open anti-drain back valve position and the closed anti-drain back valve position and a second generally annular leg secured relative to the housing.

7. The fluid filter according to claim 6 wherein the second generally annular leg includes a wall spaced from the relief valve assembly to form a chamber, the wall having an aperture fluidly connecting the chamber to the aperture in the housing.

8. The fluid filter according to claim 7 wherein the relief valve assembly includes a relief valve retainer and a spring biasing the relief valve against the relief valve retainer in a closed relief valve position, the relief valve retainer including a hole fluidly connecting the chamber to the relief valve.

9. The fluid filter according to claim 7 wherein the wall includes multiple apertures arranged circumferentially about the wall.

10. The fluid filter according to claim 6 wherein the first generally annular leg includes a first sealing portion arranged between an end disc of the filter assembly and a relief valve retainer.

11. The fluid filter according to claim 10 wherein the second generally annular leg extends from the first sealing portion to a tapping plate of the housing.

12. The fluid filter according to claim 10 wherein the first generally annular leg extends at an acute angle relative to the end disc.

13. The fluid filter according to claim 10 wherein the second generally annular leg includes a second sealing portion arranged between the relief valve retainer and the tapping plate providing the aperture in the housing.

14. The fluid filter according to claim 6 wherein the first generally annular leg and the second generally annular leg are at approximately a right angle relative to one another.

15. The fluid filter according to claim 6 wherein the closed anti-drain back valve position obstructs the relief valve from the inlet side with the relief valve in a closed relief valve position.

16. The fluid filter according to claim 1 wherein a relief valve retainer supports the relief valve and includes a hole, the anti-drain back valve includes a wall spaced from the relief valve retainer forming a chamber, the wall includes an aperture, and the aperture in the wall and the hole fluidly connect the aperture of the housing to the relief valve.

17. The fluid filter according to claim 16 wherein the hole and the aperture in the wall are misaligned with one another.

18. An anti-drain back valve for a fluid filter comprising:
a generally annular body with a generally V-shaped cross-section, the generally annular body having an apex providing a first sealing portion;
a first generally annular leg extending from the apex for providing an anti-drain back feature; and
a second generally annular leg extending from the apex to a second sealing portion and transverse to the first generally annular leg, the second generally annular leg providing a wall having at least one aperture for providing fluid communication through the anti-drain back valve to a relief valve.
